(19) United States
(12) Patent Application Publication
(10) Pub. No.: US 2015/0170205 A1
(43) Pub. Date: Jun. 18, 2015

(54) Location-based Products and Services Promotion System

(71) Applicant: Torsten Scholl, Duesseldorf (DE)

(72) Inventor: Torsten Scholl, Duesseldorf (DE)

(21) Appl. No.: 14/106,862

(22) Filed: Dec. 16, 2013

(51) Int. Cl. G06Q 30/02

(52) U.S. Cl. CPC G06Q 30/0261; G06Q 30/0255

(57) ABSTRACT

A products and services promotion system that uses the geographic location of a user or subscriber to connect the user or subscriber to a product or service provider via a subscriber's personalized product and service account page, product and service promoter website, or a products and services promotion system mobile app. The products and services promotion system activates the highlighting of a product or service upon detection of a subscriber's arrival at a location where the products or services are available for sampling or purchase. Additionally, rewards are provided to the subscriber and at least one product and service promoter based on the type of products and services that were sampled or purchased by the user or the frequency of a user's product selection, sampling, and purchase.

### BACKGROUND OF THE INVENTION

1. Field of the Invention

The present invention relates to a location-activated products and services promotion system. More specifically, the present invention relates to a products and services promotion system wherein the geographic location of the products and services promotion system user is used to connect the subscriber to a products and services site where the products and services are being promoted by one or more sponsors or promoters.

2. Description of the Background Art

Various systems and methods for promoting products or services through a computer network or the interne have been previously described. In one or more of those systems and methods, customers can establish a connection with the system, log in, and then view the available items for sale, purchasing incentive offers, or redeem a product rebate, receive product information, or request delivery of a product or product sample. An example of this system has been described in, for example, U.S. Pat. No. 5,970,469. A mobile-based products and services promotion system that allows tracking of the location of a customer has also been described in a Motorola product information article titled Mobility in Hospitality: Achieving Peak Efficiency and Teamwork to Transform the Guest Experience.

### SUMMARY OF THE INVENTION

The present invention is directed to a process of products and services promotion that allows connecting a first-time or returning user to a product or service through an access point maintained by a product and service promoter; using a geographical location of the user and the product or service to connect the user and the product or service; logging in the user to the access point; presenting a personal products and services account page to the user; presenting to the user new products or services and any previously ordered or sampled products or services offered by the product and service promoter; allowing the user to make a product or service selection from the user's personal products and services account page; awarding one or more points to the user for the selection or purchase of at least one product or service; and providing a reward to at least one product or service promoter for each product or service purchased by the user.

In a preferred embodiment of the invention, the geographical location of the user is used to allow a product or service to be enabled, activated, made available, or highlighted to enable the user to select and purchase a product or service within his present geographical location. The selection, enabling, activating, or highlighting of the product or service can be performed within or via a computer program, internet website, online account, or mobile app. The selection, enabling, activating, or highlighting of the product or service may also be performed by using appropriate environmental setting changes within a location to call the user or customer's attention to the availability of the product and service for sampling or purchase.

In accordance with the invention, a reward may be further provided to one or more product and service promoters or partners that includes a share of the placement cost and an additional reward if the selected or sampled product or service is purchased by the user. One or more points may also be awarded to the user for sampling or purchasing a product or service that are being promoted by one or more product and service promoters. The one or more points can then be used as virtual currency for one or more additional product or service sampling and purchase under the products and services promotion system.

### BRIEF DESCRIPTION OF THE DRAWINGS

FIG. 1 is a flow diagram illustrating a method of promoting a product or service in accordance with one embodiment of the present invention.

FIG. 2 is a flow diagram illustrating a method of promoting a product or service in accordance with another embodiment of the present invention.

FIG. 3 is a flow diagram illustrating a method of promoting a product or service in accordance with still another embodiment of the present invention.

### DETAILED DESCRIPTION OF THE VARIOUS EMBODIMENTS OF THE INVENTION

The present invention relates to a process of providing rewards to a user, buyer, client, or customer via a single or multiple promoters using a computer system or computer network, wireless or otherwise. As used herein, “user” or “subscriber” refers to the entity that samples or purchases a product or service being promoted by one or more product or service promoters. As used herein, “reward” refers to incentives, points, discounts, upgrades, and other rewards in the form of additional products and services, which are offered for free, discounted, or otherwise. As used herein, “product and service promoter” refers to one or more entities that co-sponsor or co-promote a product or service as partners in the products and services promotion method of the present invention. The promoter or partner maybe a manufacturer, distributor, promoter, seller, or licensor of the product or service being offered to the user. For example, a hotel may partner with a product manufacturer to co-promote a new product or service under the manufacturer's brand name or label or under a hotel's in-house brand name.

In one embodiment, the process comprises connecting a first-time or returning user to a product or service through an access point maintained by a product and service promoter; using a geographical location of the user and the product or service to connect the user and the product or service; logging in the user to the access point; presenting a personal products and services account page to the user; allowing initial entry of personal information in the personal products and services account page of the first-time user; allowing viewing of previously stored, updated, and other related information in the personal products and services account page of the returning user; presenting to the user new products or services and any previously ordered or sampled products or services offered by the product and service promoter; allowing the user to make a product or service selection from the user's personal products and services account page; awarding one or more points to the user for the selection, sampling or purchase of at least one product or service; and providing a reward to the product and service promoter for each product or service purchased by the user.

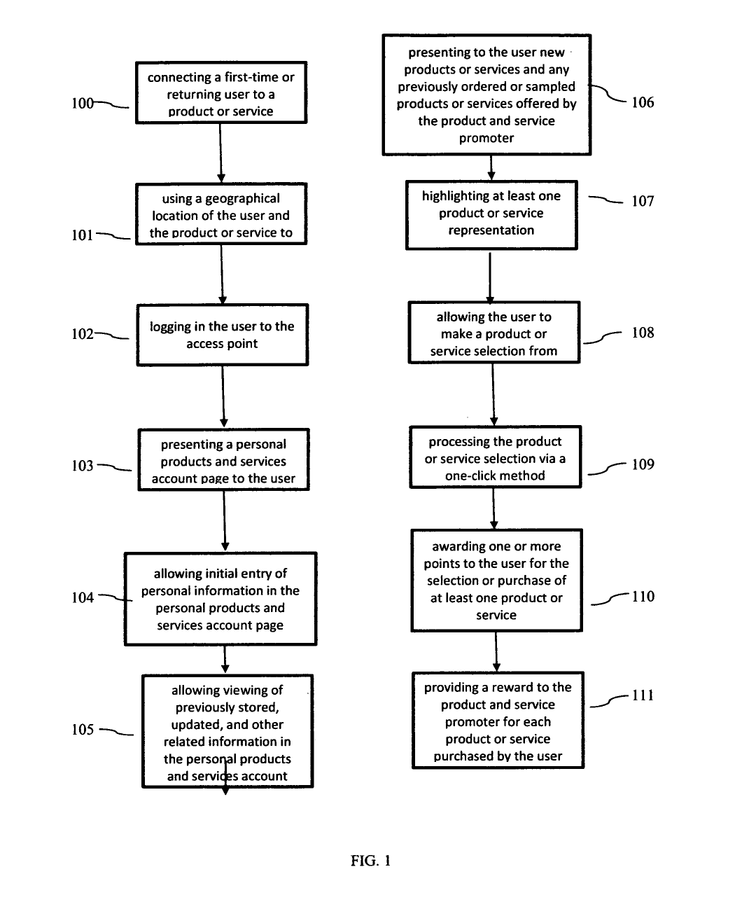

In another embodiment, as shown in FIG. 1, the process of promoting products and services comprises: connecting a first-time or returning user to a product or service through an access point maintained by a product and service promoter (100); using a geographical location of the user and the product or service to connect the user and the product or service (101); logging in the user to the access point (102); presenting a personal products and services account page to the user (103); allowing initial entry of personal information in the personal products and services account page of the first-time user (104); allowing viewing of previously stored, updated, and other related information in the personal products and services account page of the returning user (105); presenting to the user new products or services and any previously ordered or sampled products or services offered by the product and service promoter (106); highlighting at least one product or service representation through at least one of (i) a change in one or more environmental settings of a location wherein a product or service is being offered; and (ii) a change in the appearance of the at least one product or service representation while the user is logged-in on the personal products and services account page, a product and service promoter website, or a products and services promotion system mobile app (107); allowing the user to make a product or service selection from the user's personal products and services account page (108); processing the product or service selection via a one-click method (109); awarding one or more points to the user for the selection or purchase of at least one product or service (110); and providing a reward to the product and service promoter for each product or service purchased by the user (111).

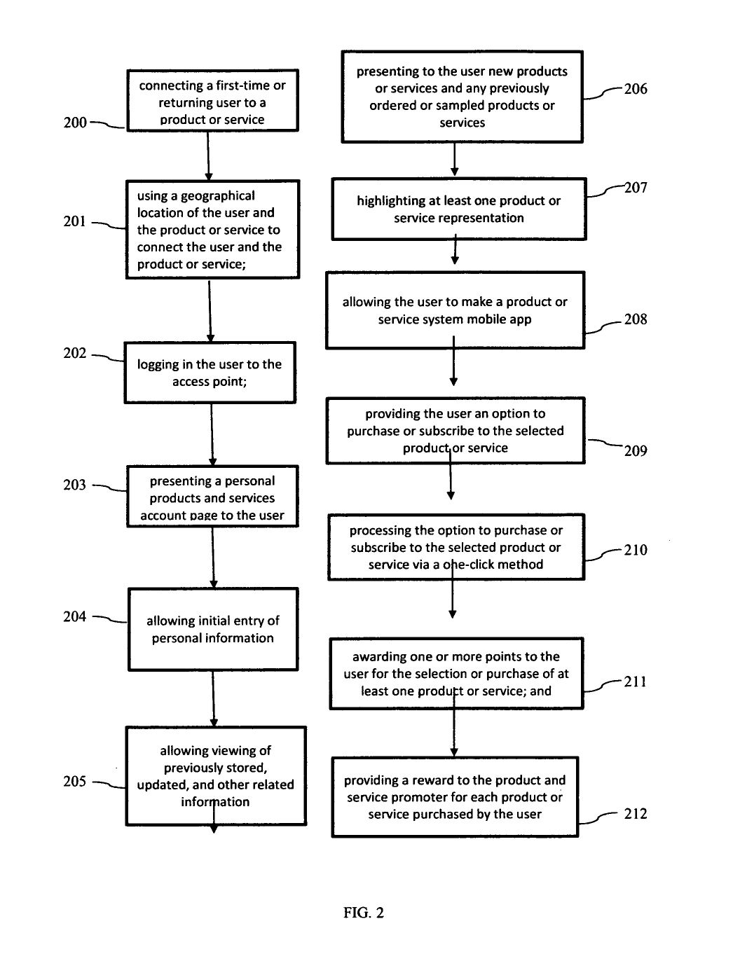

FIG. 2 shows another embodiment of the present invention directed to a process of promoting products and services comprising: connecting a first-time or returning user to a product or service through an access point maintained by a product and service promoter (200); using a geographical location of the user and the product or service to connect the user and the product or service (201); logging in the user to the access point (202); presenting a personal products and services account page to the user (203); allowing initial entry of personal information in the personal products and services account page of the first-time user (204); allowing viewing of previously stored, updated, and other related information in the personal products and services account page of the returning user (205); presenting to the user new products or services and any previously ordered or sampled products or services offered by the product and service promoter (206); highlighting at least one product or service representation through a change in one or more environmental settings of a location wherein a product or service is being offered, wherein the environmental settings change is performed via at least one of Bluetooth, WIFI, NFC, RFID, wireless transceiver, network server, local area network, wide area network, computer program, website, or a mobile app (207); allowing the user to make a product or service selection from the personal products and services account page, a product and service promoter's website, or a products and services promotion system mobile app (208); providing the user an option to purchase or subscribe to the selected product or service upon selection of a product or service from the user's personal products and services account page, product and service promoter's website, or products and services promotion system mobile app (209); processing the option to purchase or subscribe to the selected product or service via a one-click method (210); awarding one or more points to the user for the selection or purchase of at least one product or service (211); and

providing a reward to the product and service promoter for each product or service purchased by the user (212).

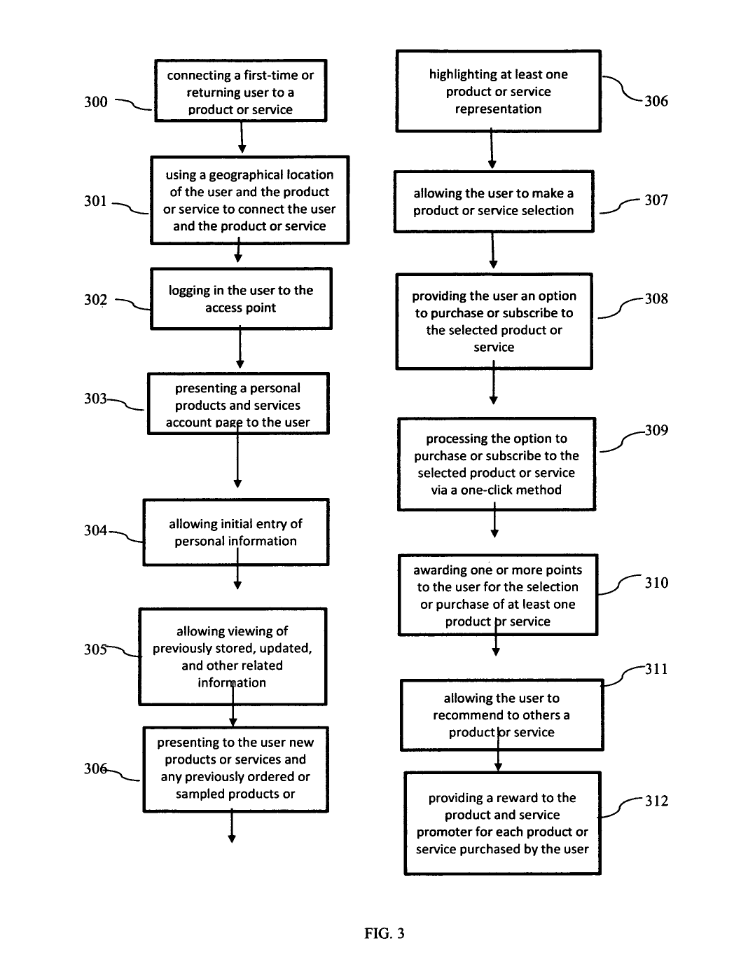

FIG. 3 shows another embodiment of the present invention. In this embodiment, the process of promoting products and services comprises: connecting a first-time or returning user to a product or service through an access point maintained by a product and service promoter (300); using a geographical location of the user and the product or service to connect the user and the product or service (301); logging in the user to the access point (302); presenting a personal products and services account page to the user (303); allowing initial entry of personal information in the personal products and services account page of the first-time user (304); allowing viewing of previously stored, updated, and other related information in the personal products and services account page of the returning user (305); presenting to the user new products or services and any previously ordered or sampled products or services offered by the product and service promoter (306); highlighting at least one product or service representation through a change in one or more environmental settings of a location wherein a product or service is being offered, wherein the environmental settings changes is performed via at least one of Bluetooth, WIFI, NFC, RFID, wireless transceiver, network server, local area network, wide area network, computer program, website, or a mobile app (307); allowing the user to make a product or service selection from at least one of the personal products and services account page, a product and service promoter's website, or a products and services promotion system mobile app (308); providing the user an option to purchase or subscribe to the selected product or service upon selection of a product or service from the user's personal products and services account page, product and service promoter's website, or products and services promotion system mobile app (309); processing the option to purchase or subscribe to the selected product or service via a one-click method (310); awarding one or more points to the user for the selection or purchase of at least one product or service (311); allowing the user to recommend to others a product or service being offered under a rewards program via the personal products and services account page, product and service promoter's website, or a products and services promotion system mobile app (312); and providing a reward to the product and service promoter for each product or service purchased by the user (313).

In the preferred embodiment for promoting a product or service, the geographical location of the user preferably allows at least one of enabling, activation, notification or highlighting (herein collectively referred to as “highlighting”) of a product or service of interest to the user. The highlighting of the at least one product or service, or both, may take place indoors or outdoors. In one embodiment, the highlighting occurs inside an office, room, or building where the product or service is offered. The highlighting of the at least one product or service may be performed through a change in one or more environmental settings of a location such as a hotel room or an outdoor tent party. Such environmental setting changes may involve the flashing of lights surrounding a featured product, activation of a video, music player or movement that highlights a product or service being promoted, etc. In still another embodiment, the highlighting of the product or service is performed within or via at least one of computer program, internet website, online account, or mobile app. In a further embodiment of the invention, the highlighting of a product or service may be performed using a change in one or more environmental settings of an indoor or outdoor location in conjunction with the use of at least one of the following: computer program, internet website, online account, or mobile app.

Preferrably, the highlighting of the product or service is performed by a use of visual or audio cue or notification. For example, the highlighting of the product or service may be performed by activating the blinking or flashing of lights surrounding the featured product or service, or by displaying a video clip or image or playing a music featuring the product or service. The highlighting of the product or service may go on continuously until disabled by the user.

The user's geographical location preferably triggers the highlighting of the product or service under the process used to promote the product or service. For example, the product or service highlighting may be triggered by the user's arrival at a hotel or an office. As an illustration, upon the user's arrival at his hotel room, a video clip or image featuring a product or service may begin playing. Also, the video or image or movement may be used to remind the user that a product, for example, is available for sampling or purchase in the user's hotel room refrigerator, pantry, restaurant, or gift shop in the hotel.

The promotion of a product or service is preferably triggered by the highlighting of the product or service preferably while the user is logged in to the user's personalized account web page or the promoters' webpage or while running a mobile app provided by the one or more products and services promotion system partners or co-promoters. The triggering of the product highlighting also preferably occurs in conjunction with the use of a computer system at the location where the product or service is being offered for sampling or purchase. In a preferred embodiment, the triggering of the highlighting of the product or service preferably occurs while the user is logged in to the personalized account web page or while running a mobile app provided by the one or more products and services promotion system partners or co-promoters in conjunction with the computer system or computer network of the location where the product or service is being offered for sampling or purchase.

In an alternative embodiment, one or more sensors in a given location may trigger the highlighting of the product or service upon detection of the user's arrival at the location via the user's mobile device. Various devices such as Bluetooth, WIFI, NFC, RFID, etc. may be used to detect the user's arrival, for example, and wireless LAN can be used to provide hotspots in various locations of a building to allow detection of the user's location. The triggering of the product or service highlighting may also occur during the user's registration at the front desk of a building such as a hotel.

Within the mobile app, website, or computer program, the highlighting of at least one product or service representation may occur via flashing, blinking, movement, change in orientation, change in color, or change in size of the at least one product or service representation. As used herein, a “product or service representation” refers to symbols, icons, labels, brand names, images, drawings, or logos of the product or service being offered for sampling or for sale. A movement of a product or service representation may involve the playing of a video clip or the display of an image or a set or collage of images that show the various features of a product or service or a physical movement of the product or service.

In a preferred embodiment of the invention, the selection of the product or service by the user allows viewing of a product or service description. Preferably, the product or service description includes price, payment option, and available rewards or points. The process also preferably provides the user an option to purchase or subscribe to the selected product or service. In one embodiment of the invention, a user's scanning of a QR (quick response) or bar code, for example, of the product being promoted allows quick delivery of the product to the user's location. The scanning of the QR or bar code may also include an option to send a scanned product to be sent to a specific address or location provided by the user. In a preferred embodiment of the invention, the processing of a product or service upon selection by a user for sampling or purchase occurs via a one-click method.

In a further embodiment of the invention, a user's scanning a product's QR or bar code activates the highlighting of a different product or service that may also be of interest to the user. The scanning of the product's QR or bar code may also activate the showing of the rewards already accumulated by the user through, for example, a pop-up message within the mobile app. In a preferred embodiment, the scanning of a product's QR or bar code automatically debits the product's cost from the user's debit or credit card or records and stores the purchase transaction into the location's computer network for later billing against the user's account.

Various types of products may be offered for sampling within the user's location, such as a hotel room, and may include various food and beverages in the mini-bar and refrigerator, as well as various products such as shampoo, conditioner, robes, towels, and perfumes that are available inside the hotel room's bathroom. In one embodiment of the invention, the scanning of the QR or bar code of these products activates the pre-packaging of the specific selection of products scanned by the user so that the products are made available to the user on short-notice or before the user's departure from a specific location.

In one embodiment of the invention, the change in appearance of the at least one product or service representation can be deactivated by selecting a product or service representation such as by clicking on the icon, label, or logo of the highlighted product or service. Alternatively, the product or service representation's change in appearance can be deactivated by the user's logging off his personalized account page, by logging out of the rewards mobile app, or by simply turning off his mobile device.

In another preferred embodiment of the invention, the one or more points awarded to the user can be used as virtual currency for one or more purchases under the products and services promotion system. The reward provided to the location provider may include a share of the placement cost for the product or service, and an additional reward if the selected product or service is purchased by the user. The reward given to the user may be used for hotel room discounts, restaurant meal discounts, or discounts on the products and services being offered under the products and services promotion system. The rewards may also be exchanged for additional perks such as free or discounted in-house movies or free snacks or meals. Rewards may also be traded with other users. In a preferred embodiment of the invention, a user may collect additional rewards by recommending the products or services offered under the products and services promotion system to friends, relatives, and families. The product or service recommendation may be accomplished by the user's entering information such as the email address, at least one social media account, or cell phone number of one or more friends, relatives, and families. Further rewards may be given to the user if the recommended friends, families, or relatives sample or purchase the one or more products or services being promoted under the products and services promotion system.

I claim:

1. A process of products and services promotion system comprising:
a. connecting a first-time or returning user to a product or service through an access point maintained by a product and service promoter;
b. using a geographical location of the user and the product or service to connect the user and the product or service;
c. logging in the user to the access point;
d. presenting a personal products and services account page to the user;
e. allowing initial entry of personal information in the personal products and services account page of the first-time user;
f. allowing viewing of previously stored, updated, and other related information in the personal products and services account page of the returning user;
g. presenting to the user new products or services and any previously ordered or sampled products or services offered by the product and service promoter;
h. allowing the user to make a product or service selection from the user's personal products and services account page;
i. awarding one or more points to the user for the selection or purchase of at least one product or service; and
j. providing a reward to the product and service promoter for each product or service purchased by the user.

2. The process of claim 1, wherein a processing of a product or service upon selection by a user for sampling or purchase occurs via a one-click method.

3. The process of claim 2, wherein the geographical location of the user allows highlighting of a product or service being promoted.

4. The process of claim 3, wherein the highlighting of the product or service occurs indoors or outdoors.

5. The process of claim 3, wherein the highlighting of the product or service being promoted occurs inside an office, room, or building.

6. The process of claim 3, wherein the highlighting of the product or service is performed by a use of at least one of visual, audio, and audio-visual notification.

7. The process of claim 3, wherein the highlighting of the product or service being promoted is performed via at least one of computer program, internet website, online account, or mobile app.

8. The process of claim 3, wherein the highlighting of the product or service being promoted is performed through a change in one or more environmental settings of a location wherein the product or service is being promoted.

9. The process of claim 3, wherein the product or service selection allows viewing of a product or service description of the product or service being promoted.

10. The process of claim 9, wherein the product or service description includes price, payment option, and available rewards or points.

11. The process of claim 3, further providing the user an option to sample, purchase or subscribe to the selected product or service.

12. The process of claim 3, wherein at least one product or service representation is highlighted.

13. The process of claim 12, wherein the at least one product or service representation is highlighted through a change in appearance of the at least one product or service representation while the user is logged-in on at least one of the user's personal products and services account page, product and service promotion mobile app, or a webpage of one or more product and service promoters.

14. The process of claim 13, wherein the change in appearance of the at least one product or service representation occurs by flashing, blinking, movement, change in orientation, change in color, or change in size of the at least one product or service representation.

15. The process of claim 13, wherein the change in appearance of the at least one product or service representation can be deactivated by selecting a product or service representation.

16. The process of claim 3, wherein the reward provided to the location provider includes a share of the placement cost and an additional reward if the selected product or service is purchased by the user.

17. The process of claim 3, wherein the one or more points awarded to the user can be used as virtual currency for one or more purchases under the products and services promotion system.

18. The process of claim 3, wherein the selected product can be sent to an address provided by the user.

19. A process of products and services promotion system comprising:
a. connecting a first-time or returning user to a product or service through an access point maintained by a product and service promoter;
b. using a geographical location of the user and the product or service to connect the user and the product or service;
c. logging in the user to the access point;
d. presenting a personal products and services account page to the user,
e. allowing initial entry of personal information in the personal products and services account page of the first-time user;
f. allowing viewing of previously stored, updated, and other related information in the personal products and services account page of the returning user;
g. presenting to the user new products or services and any previously ordered or sampled products or services offered by the product and service promoter;
h. highlighting at least one product or service representation through at least one of (i) a change in one or more environmental settings of a location wherein a product or service is being offered; and (ii) a change in the appearance of the at least one product or service representation while the user is logged-in on the personal products and services account page, a product and service promoter website, or a products and services promotion system mobile app;
i. allowing the user to make a product or service selection from the user's personal products and services account page;
j. processing the product or service selection via a one-click method;
k. awarding one or more points to the user for the selection or purchase of at least one product or service; and
l. providing a reward to the product and service promoter for each product or service purchased by the user.

20. A process of products and services promotion system comprising:
a. connecting a first-time or returning user to a product or service through an access point maintained by a product and service promoter;
b. using a geographical location of the user and the product or service to connect the user and the product or service;
c. logging in the user to the access point;
d. presenting a personal products and services account page to the user;
e. allowing initial entry of personal information in the personal products and services account page of the first-time user;
f. allowing viewing of previously stored, updated, and other related information in the personal products and services account page of the returning user;
g. presenting to the user new products or services and any previously ordered or sampled products or services offered by the product and service promoter;
h. highlighting at least one product or service representation through a change in one or more environmental settings of a location where a product or service is being offered, wherein the environmental settings change is performed via at least one of Bluetooth, WIFI, NFC, RFID, wireless transceiver, network server, local area network, wide area network, computer program, website, or a mobile app;
i. allowing the user to make a product or service selection from the personal products and services account page, a product and service promoter's website, or a products and services promotion system mobile app;
j. providing the user an option to purchase or subscribe to the selected product or service upon selection of a product or service from the user's personal products and services account page, product and service promoter's website, or products and services promotion system mobile app;
k. processing the option to purchase or subscribe to the selected product or service via a one-click method;
l. awarding one or more points to the user for the selection or purchase of at least one product or service; and
m. providing a reward to the product and service promoter for each product or service purchased by the user.

21. A process of products and services promotion system comprising:
a. connecting a first-time or returning user to a product or service through an access point maintained by a product and service promoter;
b. using a geographical location of the user and the product or service to connect the user and the product or service;
c. logging in the user to the access point;
d. presenting a personal products and services account page to the user;
e. allowing initial entry of personal information in the personal products and services account page of the first-time user;
f. allowing viewing of previously stored, updated, and other related information in the personal products and services account page of the returning user;
g. presenting to the user new products or services and any previously ordered or sampled products or services offered by the product and service promoter;
h. highlighting at least one product or service representation through a change in one or more environmental settings of a location where a product or service is being offered, wherein the environmental settings changes is performed via at least one of Bluetooth, WIFI, NFC, RFID, wireless transceiver, network server, local area network, wide area network, computer program, website, or a mobile app;
i. allowing the user to make a product or service selection from at least one of the personal products and services account page, a product and service promoter's website, or a products and services promotion system mobile app;
j. providing the user an option to purchase or subscribe to the selected product or service upon selection of a product or service from the user's personal products and services account page, product and service promoter's website, or products and services promotion system mobile app;
k. processing the option to purchase or subscribe to the selected product or service via a one-click method;
l. awarding one or more points to the user for the selection or purchase of at least one product or service;
m. allowing the user to recommend to others a product or service being offered under a products and services promotion program via the personal products and services account page, product and service promoter's website, or a products and services promotion system mobile app; and
n. providing a reward to the product and service promoter for each product or service purchased by the user.
